(19) United States
(12) Patent Application Publication
(10) Pub. No.: US 2003/0099575 A1
(43) Pub. Date: May 29, 2003

(54) Method for preparing tungsten trioxide precursor and hydrogen sulfide gas sensor fabricated using the same

(76) Inventors: Lung-Yu Sung, Hsinchu (TW); Yingjeng James Li, Taoyuan (TW)

Correspondence Address: BIRCH STEWART KOLASCH & BIRCH, PO BOX 747, FALLS CHURCH, VA, 22040-0747, US

(21) Appl. No.: 10/177,123

(22) Filed: Jun. 24, 2002

(30) Foreign Application Priority Data
Nov. 29, 2001 (TW) 90129505

(51) Int. Cl. G01N 27/00

(52) U.S. Cl. 422/88; 422/98

(57) ABSTRACT

A method for preparing tungsten trioxide precursor and a hydrogen sulfide gas sensor made thereof. The method includes dissolving a soluble tungsten compound in a solvent to form a solution; and adding thickener to the solution to adjust the viscosity thereof. In the above method, the viscosity of the produced tungsten trioxide precursor is adjusted so that it can be coated onto a substrate by spin or screen coating. The substrate is then thermal processed to decompose the organic component to obtain tungsten trioxide. A conventional method is then applied to fabricate a hydrogen sulfide gas sensor.

### BACKGROUND OF THE INVENTION

1. Field of the Invention

The present invention relates to a method for preparing a precursor used for fabricating the sensor material of a gas sensor, in particular, a method for preparing tungsten trioxide precursor for a hydrogen sulfide gas sensor.

2. Description of the Prior Art

Hydrogen sulfide (H₂S) is a pollutant often present in the process of industrialization. Major sources of H₂S are petrochemical industry, natural gas industry, and other processes such as leather factory, paper factory, and dye factory, electroplating factory, incineration plant and wastewater process plant.

H₂S is a colorless gas having noxious odor and strong toxicity. The acceptable H₂S concentration in the air is 10 ppm and the outburst range is 4.3%˜46.0%. H₂S is a chemical neurotoxin, which causes irritation, suffocation and damage of red blood cells in humans. A mere concentration of 0.1 ppm irritates the human sense of smell and a few ppm results in strong smells of sulfur. Though the bad smell of H₂S allows smell detection, it is useless at a high concentration of H₂S, since it temporarily inhibits the function of the nerves of smell. A H₂S concentration higher than 500 ppm causes serious irritation and suffocation. Death can also result. Therefore, it is essential to provide a method for quantitative detection of hydrogen sulfide in air.

Presently, gas sensors of semiconductor type have been widely used, as they are simply-structured, easy to manufacture, consume less material and lower production costs. The principle of the gas sensors of semiconductor type is the adsorption of the gas onto the surface of the sensor material. When molecules or atoms of the gas to be sensed are adsorbed onto the surface of the sensor material, extra atoms are absorbed or released by the sensor material thereby changing the density of free electrons on the surface of the sensor material. Consequently, resistance value of the sensor material, which is then used to determine the concentration of the gas, varies. Metal oxides, usually exhibiting semiconductor properties, are mostly used as the sensor material. Examples of conventional metal oxides are SnO₂, WO₃, ZnO, TiO₂ and Fe₂O₃. The energy barriers of the grain boundary of this material in air are higher, consequently inhibiting the passing through of electrons, consequently increasing the resistance. When these materials are exposed to reducing gas, such as H₂S, CO, CH₄, Nox, SO₂, H₂, NH₃, grain boundary barrier is lowered for easy passthrough of electrons, thereby changing the resistance or conductivity greatly followed by the change of gas concentration. This is the major reason that these oxides are used for detecting gas.

Generally speaking, sensor material of the semiconductor type of gas sensor must work at high temperatures, because sufficient energy is needed for the reaction with the testing gas and to produce an obvious sensitivity. Preferable temperature is 200˜400° C.

Conventional hydrogen sulfide gas sensors have been disclosed in JP 6-18467, U.S. Pat. No. 4,822,465, U.S. Pat. No. 4,197,089 and U.S. Pat. No. 5,321,146. Jp 6-18467 discloses ammonium paratungstate {(NH₄)₁₀W₁₂O₄₁.5H₂O} as the original material, followed by thermal process to obtain tungsten trioxide powder. The powder is then sintered at 600° C. to form sensor material. However, disadvantages inherent in the above sensor material are weak structure, and weak bonding strength between powders or powder and substrate. Therefore, the overall structure is not well-built.

Another method for depositing thin films of tungsten oxide on electrodes is referred to in Jones et al., U.S. Pat. No. 4,822,465, which discusses what is known as a radio frequency sputtering technique. This technique contemplates a deposit of the sensing film by sputtering the film onto the electrodes which are, in turn, supported by a substrate. One of the shortcomings of depositing sensing films by sputtering techniques arises when dopants are added to the sensing film. If it is desirable for the sensing film composition to contain a dopant, it is preferred that the dopant be uniformly dispersed throughout the sensing compound to provide consistence in the electrical properties of the film. This is difficult to achieve using sputtering. In addition, sputtering may yield mixtures in which there is either less or more than the optimal concentration of dopant in the sputtered thin film.

Willis et al., U.S. Pat. No. 4,197,089, disclose hydrogen sulfide gas sensors with improved selectivity to hydrogen sulfide gas, which comprise a chemically formed sensor film of tungsten trioxide produced by decomposing a droplet of ammonium tungstate contained in solution and deposited on the sensor. The patent also discloses a physically formed sensor film of tungsten trioxide which is produced by sintering tungsten trioxide which is produced by sintering tungsten trioxide in the powder form on the electrode surface. One major disadvantage inherent in this technique is an inability to manipulate the microstructure of the film formed. Thereby it is difficult to anticipate the selectivity and sensitivity of the sensor.

U.S. Pat. No. 5,632,1146 discloses a method using Na(OW(OOCR)₂)₂ as the tungsten trioxide precursor, which is coated by spin coating, dip coating or spray coating onto a substrate, followed by thermal decomposition to form a tungsten trioxide sensor material on the substrate. However, expensive or toxic chemicals and inflammable compounds such as sodium are required during the process, not only are production costs increased, difficulty in processing is, as well. Moreover, the precursor must be synthesized in an isolated and dry box, which in turn makes the process more inconvenient. In addition, in the overall synthesis process, inert gas must fill the dry box, and vacuum equipment is required to extract the product, hence, the process is further complicated.

### SUMMARY OF THE INVENTION

In order to overcome the above problems, an object of the invention is to provide a method for preparing tungsten trioxide precursor as sensor material of a hydrogen sulfide gas sensor. The method is carried out in an atmospheric environment, without using dangerous chemicals or solvents. Equipment required and the overall process is much simpler as well. Consequently, production costs are lowered, and prevention from possible environmental pollutions is achieved.

The precursor provided in the invention can be deposited onto a substrate by various coating methods, such as screen printing, spin coating, vacuum sputtering, or dip coating. As a result, a simple process and mass production are obtainable.

It is another object of the invention to provide a hydrogen sulfide gas sensor with good sensitivity and selectivity.

In order to achieve the above objects, there is provided a method for preparing tungsten trioxide precursor, comprising dissolving a soluble tungsten compound in a solvent to form a solution and adding a thickener to the solution to adjust the viscosity thereof. The soluble tungsten compound is preferably tungsten hexachloride, tungsten hexabromide, tungsten oxytetrachloride, tungsten oxytetrabromide or tungstic acid. Preferable thickener is glycerol, polyethylene glycol, or cellulose and solvent is preferably alcohol, water or glycerin.

The invention also provides a hydrogen sulfide gas sensor, which comprises: a substrate; a pair of upper electrodes formed on one side of the substrate; a pair of lower electrodes formed on the other side of the substrate; a heater formed between the lower electrodes to connect the lower electrodes; a tungsten trioxide layer formed between the upper electrodes, wherein the tungsten trioxide is formed by the thermal decomposition and sintering of the precursor prepared above; a catalyst layer formed above the tungsten trioxide layer; and a number of signal lines to connect the upper electrodes and the lower electrodes. Preferable electrodes are Au, Pt, Ag/Pd or Ni. The heater is made of resistor material, such as RuO₂, W, Pt and Ni. Preferable catalyst layer is Au or Pd, and substrate is preferably ceramic, silicon, glass or plastic.

The present invention will become more fully understood from the detailed description given hereinbelow and the accompanying drawings, given by way of illustration only and thus not intended to be limitative of the present invention.

### BRIEF DESCRIPTION OF THE DRAWINGS

FIG. 1A illustrates the top view of the hydrogen sulfide gas sensor according to the invention.

FIG. 1B illustrates the side view of the hydrogen sulfide gas sensor according to the invention.

FIG. 1C illustrates the bottom view of the hydrogen sulfide gas sensor according to the invention.

FIG. 2 is a graphical representation of the sensitivity of the 4^{th} embodiment.

FIG. 3A is a graphical representation of the response time curve according to 4^{th} Embodiment.

FIG. 3B is a graphical representation of the response time curve of the comparative embodiment.

FIG. 4 is a graphical representation of the relationship between resistance and concentration.

FIG. 5 is a graphical representation of the relationship between voltage and concentration.

FIG. 6 is a graphical representation of the reproducibility according to 4^{th} Embodiment.

### DETAILED DESCRIPTION OF THE PREFERRED EMBODIMENTS

Preparation of Sensor Material Precursor I

10 ml of alcohol was placed in a 20 ml flask, followed by the addition of 1.0 g of tungsten hexachloride (WCl₆). A magnetic stirrer was then put into the flask to fully dissolve tungsten hexachloride. When the solution was completely dissolved, a total amount of 1.0 g of PVA was slowly added into the solution and stirred until PVA was completely dissolved.

Preparation of Sensor Material Precursor II

2.5 g of tungstic acid (H₂WO₄) was placed into a 20 ml flask, followed by adding glycerol until the total volume was 10 ml. A magnetic stirrer was then put into the flask to fully dissolve tungstic acid.

Preparation of Catalyst

0.4 g of organic Au, 0.2 g of organic Pd and 10 ml of O-xylene were placed in a 20 ml flask, followed by spin stirring with a magnetic stirrer inside the flask until fully dissolved.

Preparation of Sensor

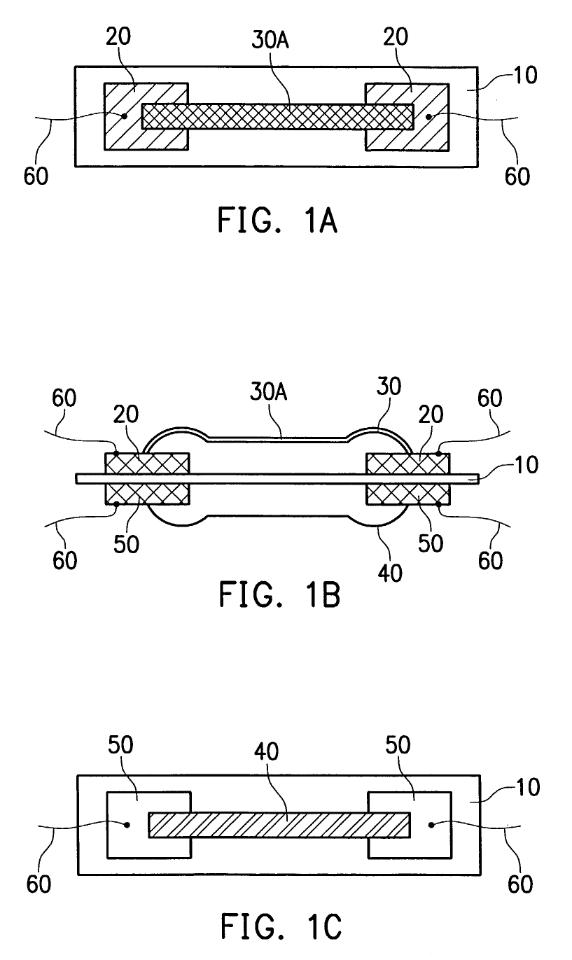

A pair of upper electrodes 20 and a pair of lower electrodes 50 were screen printed onto a ceramic substrate 10, as shown in FIG. 1A˜1C. A resistor heater 40 was then screen printed between the lower electrodes using RuO₂. The sensor material precursor prepared in the first two embodiments were then spin coated or screen printed between the upper electrodes 20. At high temperatures, the precursor was decomposed and sintered to form a Tungsten Trioxide sensor material layer 30. Next, the catalyst material prepared in 3^{rd} Embodiment was spin coated onto the Tungsten Trioxide sensor material layer 30. Again, the catalyst layer was subjected to high temperature sintering to decompose as a catalyst layer 30A. A number of signal lines 60 were then connected to the electrodes, followed by wiring and packaging to produce a hydrogen sulfide gas sensor.

Next, tests for sensitivity, response time, selectivity, reproducibility, resistance changes vs concentration variations of the hydrogen sulfide gas sensor were performed. A similar kind of hydrogen sulfide gas sensor available on the market was used as a comparative embodiment to test for sensitivity and response time.

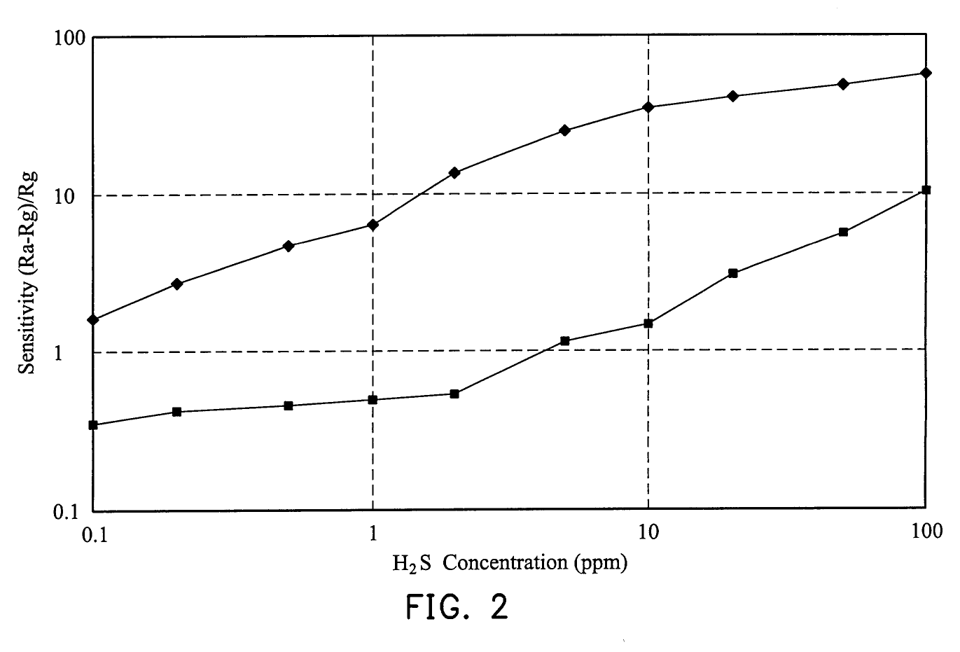

Sensitivity is the degree of of a sensor's ability to detect gas, which is obtained by ((Ra−Rg)/Rg), wherein Ra is the resistance of the sensor in air, and Rg is the resistance of the sensor in testing gas. The test for sensitivity was carried out in 250° C., where the required heat was provided by RuO₂ resistor heater on the substrate. FIG. 2 illustrates the performance of the hydrogen sulfide gas sensor, wherein “..” represents the hydrogen sulfide gas sensor prepared in this embodiment, and “<” represents a similar kind of hydrogen sulfide gas sensor available on the market. It is observed from FIG. 2 that a good sensitivity was obtained when the concentration of H₂S is a few ppb, and the sensitivity is 6 times higher when H₂S is 1 ppm, and it reaches as high as 34 times when the concentration is 10 ppm (TLV). Lower limit of current hydrogen sulfide gas sensor is a few ppm, which is not satisfactory for the requirement of environmental/industrial safety. Since TLV value is 10 ppm, a good hydrogen sulfide gas sensor must be able to release alarm signals at a concentration far less than 10 ppm. Therefore, based on the above results, the gas sensor provided in this invention exhibits satisfactory sensitivity.

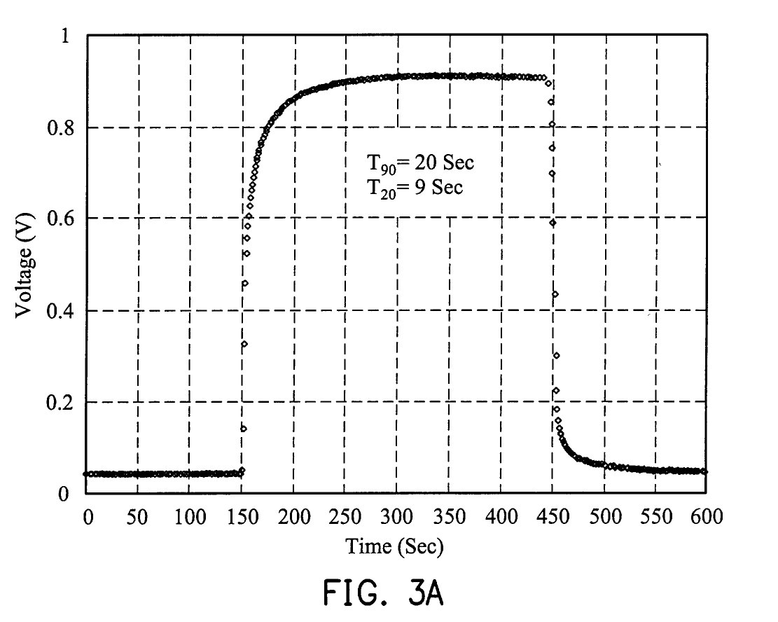

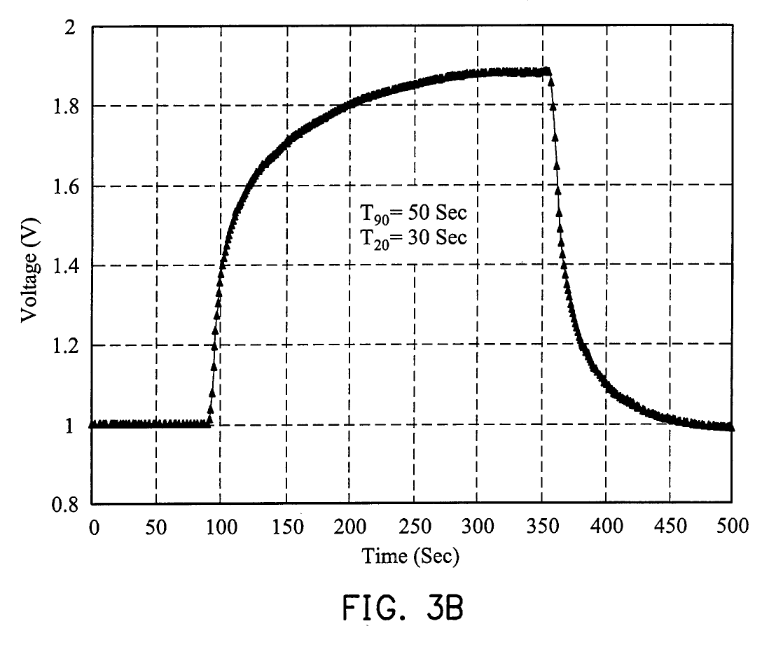

Response time of a gas sensor is represented by T₉₀ and T₂₀. T₉₀ is the time needed for the output signals of the sensor to reach 90% stability and T₂₀ is the time needed for the output signals to reach 20% of the original value after removing the testing gas. The result is shown in FIG. 3A. Output voltage of the gas sensor of the invention shows a stable curve in clean air, when 10 ppm of hydrogen sulfide gas is applied, the output voltage reaches another new stable value in 90 seconds. And when the hydrogen sulfide gas is stopped, the output voltage quickly returned to the original value in clean air. T₉₀ and T₂₀ are respectively 20 sec and 9 sec. FIG. 3B illustrates the result from a commercially available hydrogen sulfide gas sensor, where T₉₀ and T₂₀ are 50 sec and 30 sec respectively. Again, the hydrogen sulfide gas sensor provided in this invention demonstrates superior response time compared to the current ones.

Selectivity is the ability of a sensor to distinguish between various testing gases and the effects and disturbance of other gases on the sensor. Being an important aspect of a gas sensor, a gas sensor with poor selectivity misjudges the concentration of a testing gas as a result of disturbing signals released by other gases. Serious consequences can occur.

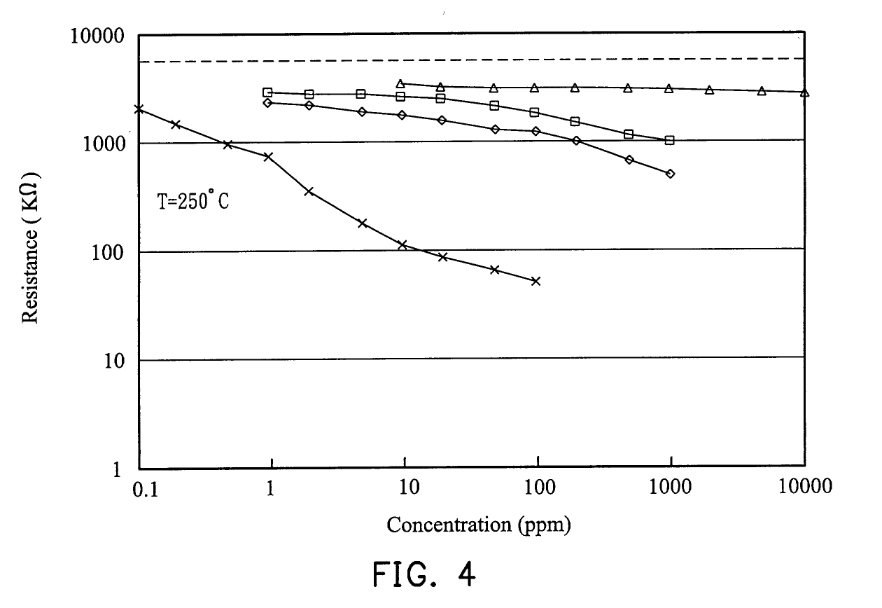

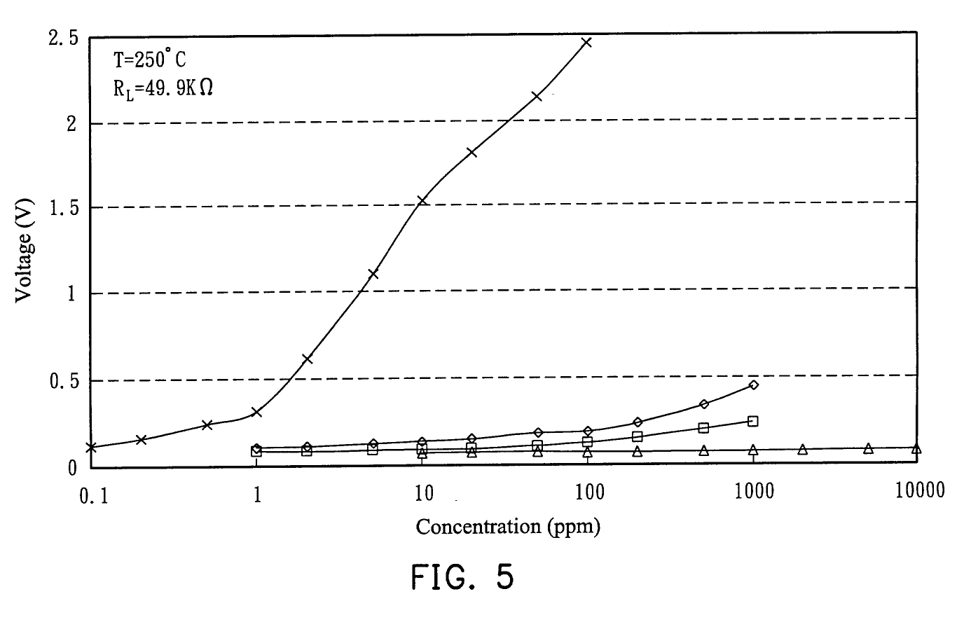

FIGS. 4 and 5 respectively illustrate the relationship of the changes of resistance vs concentration and changes of voltage vs concentration. A good selectivity to hydrogen sulfide (x) is observed from the curves, where disturbances caused by CO(□), CH₄(Δ), and H₂(⋄) are negligible.

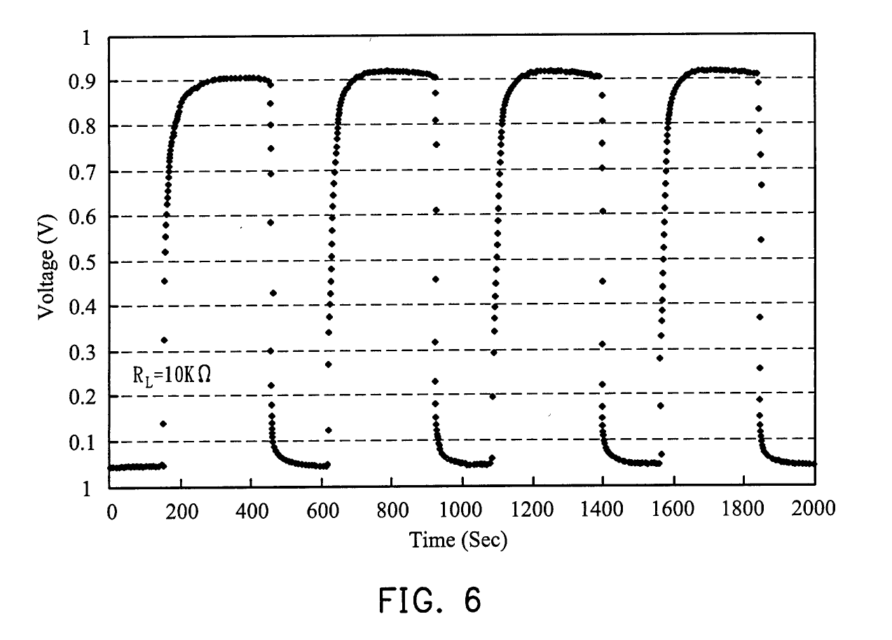

Reproducibility is the ability of the same sensor to continuously output signals. Refer to FIG. 6, which shows the results at 250° C., 10 ppm of H₂S. It is observed from the curve that a good reproducibility of the gas sensor is obtained using the precursor provided in the invention.

The foregoing description of the preferred embodiments of this invention has been presented for purposes of illustration and description. Obvious modifications or variations are possible in light of the above teaching. The embodiments were chosen and described to provide the best illustration of the principles of this invention and its practical application to thereby enable those skilled in the art to utilize the invention in various embodiments and with various modifications as are suited to the particular use contemplated. All such modifications and variations are within the scope of the present invention as determined by the appended claims when interpreted in accordance with the breadth to which they are fairly, legally, and equitably entitled.

What is claimed is:

1. A method for preparing tungsten trioxide precursor, comprising:
(a) dissolving soluble tungsten compound in a solvent to form a solution; and
(b) adding thickener to the solution to adjust the viscosity thereof.

2. The method as claimed in claim 1, wherein the soluble tungsten compound is tungsten hexachloride, tungsten hexabromide, tungsten oxytetrachloride, tungsten oxytetrabromide or tungstic acid.

3. The method as claimed in claim 1, wherein the thickener is glycerol, polyethylene glycol, or cellulose.

4. The method as claimed in claim 1, wherein the solvent is alcohol, water or glycerin.

5. A hydrogen sulfide gas sensor, comprising:
a substrate;
a pair of upper electrodes formed on one side of the substrate;
a pair of lower electrodes formed on the other side of the substrate;
a heater mounted between the lower electrodes for connecting the lower electrodes;
a tungsten trioxide layer formed between the upper electrodes, wherein the tungsten trioxide is formed by the thermal decomposition and sintering of the precursor as claimed in claim 1;
a catalyst layer formed above the tungsten trioxide layer; and
a number of signal lines to connect the upper electrodes and the lower electrodes.

6. The hydrogen sulfide gas sensor as claimed in claim 5, wherein the electrodes are Au, Pt, Ag/Pd or Ni.

7. The hydrogen sulfide gas sensor as claimed in claim 5, wherein the heater is made of resistor material.

8. The hydrogen sulfide gas sensor as claimed in claim 7, wherein the resistor material is RuO₂, W, Pt or Ni.

9. The hydrogen sulfide gas sensor as claimed in claim 5, wherein the catalyst layer is Au or Pd.

10. The hydrogen sulfide gas sensor as claimed in claim 9, wherein the substrate is ceramic, silicon, glass or plastic.
